(19) United States
(12) Patent Application Publication
(10) Pub. No.: US 2025/0238888 A1
(43) Pub. Date: Jul. 24, 2025

(54) Artificial Intelligence to Reduce Bias In Police Reporting

(71) Applicant: Authenticating.com, LLC, Santa Monica, CA (US)

(72) Inventor: Steven Brandon Ward, Palm Beach Gardens, FL (US)

(21) Appl. No.: 18/659,406

(22) Filed: May 9, 2024

Related U.S. Application Data
(60) Provisional application No. 63/622,626, filed on Jan. 19, 2024.

(51) Int. Cl. G06Q 50/26

(52) U.S. Cl. CPC G06Q 50/265

(57) ABSTRACT

Aspects of the disclosure are directed to automatically drafting police reports using a collaborative artificial intelligence (AI) system that can reduce bias in policing. The collaborative AI system can receive sensor data associated with an occurrence to generate a recreation of the occurrence in near-real time as the occurrence is underway. The collaborative AI system can utilize the recreation to automatically draft a police report for the occurrence in an unbiased and comprehensive manner.

### BACKGROUND

Drafting a police report after an interaction between a police officer and an individual is a time-consuming and difficult process. Drafting the police report requires the police officer to consider and remember a large number of details about the interaction, sometimes at a time significantly after that interaction has occurred. While a police officer may have handwritten notes immediately after the interaction, the handwritten notes may be illegible due to poor handwriting, leave out information, or be lost or otherwise unavailable. This can result in inaccuracies in the police report as the police officer may misremember aspects of the interaction. Further, biases may influence how the police officer remembers the interaction, e.g., a police officer may misremember a suspect of a particular race was more aggressive in an interaction and draft their report as if the suspect was aggressive. Police reports may also vary in quality based on the particular officer drafting the report. For example, one officer may prepare a well-written, highly detailed report while another officer may prepare a report that has numerous grammatical errors and leaves out vital information. This can lead to difficulty in drafting police reports with accuracy and consistency, as well as accurately and consistently keeping a record of past interactions overall.

### BRIEF SUMMARY

Aspects of the disclosure are directed to automatically drafting police reports using a collaborative artificial intelligence (AI) system that can improve accuracy and reduce bias in police reporting. The collaborative AI system can receive sensor data associated with an occurrence to generate a recreation of the occurrence in near-real time as the occurrence is underway. The collaborative AI system can utilize the recreation to automatically draft a police report for the occurrence in an unbiased and comprehensive manner.

Automatically drafting police reports using the collaborative AI system can reduce administrative burden, as police officers no longer need to spend a disproportionate amount of time writing reports. Instead, the police officers can be free to focus on improving overall police presence, responsiveness, and community engagement. Further, automatically drafting police reports using the collaborative AI system can enhance reporting accuracy and completeness, as the AI system can process the received sensor data objectively and consistently, avoiding potential human errors such as an inability to recall certain details or a biased view of what transpired.

An aspect of the disclosure provides for a method for police reporting including: receiving, by one or more processors, input data associated with an interaction between an individual and a police officer; processing, by the one or more processors, the input data using a collaborative artificial intelligence (AI) model to generate a recreation of the interaction as the interaction is occurring; determining, by the one or more processors, the interaction is complete; processing, by the one or more processors, the recreation using the collaborative AI model to generate a police report of the interaction; and outputting, by the one or more processors, the police report.

Another aspect of the disclosure provides for a system including: one or more processors; and one or more storage devices coupled to the one or more processors and storing instructions that, when executed by the one or more processors, cause the one or more processors to perform operations for the method for police reporting.

Yet another aspect of the disclosure provides for a non-transitory computer readable medium for storing instructions that, when executed by one or more processors, cause the one or more processors to perform operations for the method for police reporting.

In an example, the input data includes at least one of video data, audio data, or image data captured using a plurality of sensors. In another example, the plurality of sensors includes at least one of temperature sensors, proximity sensors, accelerometers, infrared sensors, smoke, gas, or alcohol sensors, audio recorders, or video recorders.

In yet another example, the method further includes receiving, by the one or more processors, historical data associated with the individual and the police officer. In yet another example, the method further includes processing the historical data using the collaborative AI model to generate the recreation of the interaction as the interaction is occurring. In yet another example, processing the recreation to generate the police report of the interaction is further based on the historical data. In yet another example, the historical data includes at least one of prior police reports, psychological reports, or identification information.

In yet another example, processing the input data using a collaborative artificial intelligence (AI) model to generate a recreation further includes synchronizing a plurality of sensors to receive consistent streams of input data.

In yet another example, outputting the police report further includes storing the police report or transmitting the police report to a device associated with the police officer or a dispatch. In yet another example, the device associated with the police officer or dispatch includes at least one of a laptop, smartphone, or smartwatch.

### BRIEF DESCRIPTION OF THE DRAWINGS

FIG. 1 depicts a block diagram of an example environment for a collaborative AI system according to aspects of the disclosure.

FIG. 2 depicts a scenario in which a law enforcement officer conducts a traffic stop for a suspicious traffic violation using the collaborative AI system according to aspects of the disclosure.

FIG. 3 depicts a block diagram of an example collaborative AI system according to aspects of the disclosure.

FIG. 4 depicts a block diagram of an example unbiased police reporting system according to aspects of the disclosure.

FIG. 5 depicts a flow diagram of an example process for automatically drafting police reports using a collaborative AI system according to aspects of the disclosure.

### DETAILED DESCRIPTION

The technology relates generally to automatically drafting police reports using a collaborative artificial intelligence (AI) system, such as for reducing bias in policing. By reducing bias in policing, individuals who interact with police officers may be treated more equitably. The collaborative AI system includes one or more AI models configured to recreate an interaction with a police officer in near-real time as the interaction is occurring and use that recreation to automatically generate a police report. The collaborative AI system can generate a police report that is more accurate and comprehensive than a police report drafted by a police officer after the interaction has occurred.

The AI models of the collaborative AI system can be trained with training data from prior police reports, police documentation, individual documentation, relevant statutes like criminal codes, and/or any other documentation associated with interactions with police officers. The AI models can further be trained with training data from image, audio, and/or video data captured by one or more sensors attached to a police officer or police vehicle, such as a body camera or dashboard camera, during an interaction between a police officer and an individual. The AI models can also be trained with training data from various departments, such as law enforcement departments and fire departments, hospitals, clinics, shelters, food kitchens, public transit, and/or departments of health, human services, social services. The AI models can be trained with the training data to recreate interactions with a police officer in near-real time based on input data received as the interaction is occurring. The AI model can further be trained with the training data to utilize the generated recreation for automatically generating a police report of the interaction.

The collaborative AI system can be used by police officers during interactions with individuals. The collaborative AI system can assist the police officer by generating a recreation of the interaction, allowing the police officer to focus on the interaction rather than details of the interaction that may be needed for a report to be drafted at a later time. Individuals may refer to suspects, offenders, bystanders, witnesses, and/or victims, as examples. While described with respect to police officers, the collaborative AI system can be used by any official or first responder where a summary report needs to be prepared after an occurrence, such as firefighters, military, emergency medical technicians, paramedics, social workers, negotiators, as examples. For example, paramedics and/or firefighters arriving at the scene of a building fire may use the collaborative AI system to generate a recreation of the scene as the fire fighters rescue victims trapped in the building and the paramedics interact with victims needing medical assistance. The collaborative AI system can then generate a report of the building fire based on the recreation.

The collaborative AI system can utilize one or more sensors and/or databases to receive input data associated with the interaction between the police officer and the individual for generating the recreation in near real-time, e.g., as the interaction is occurring. The receipt of input data may be continual, such as via streaming of data, as an example. The one or more sensors can include one or more cameras to capture audio, video, and/or image data of the interaction. The one or more sensors can be included on the police officer, e.g., a body camera, held by the police officer, e.g., a smart phone camera or other smart device, and/or included on a vehicle of the police officer, e.g., a dashboard camera. The one or more databases can include registries, prior police reports, and/or any other documentation for identifying the police officer and the individual.

The collaborative AI system can generate the recreation in near real-time by processing the input data as it is received by the one or more sensors. The processing of the input may be continual, such as via streaming of data, as an example. Once an interaction is complete, the collaborative AI system can determine the recreation is complete as well and stop processing the input data. Alternatively, or additionally, the police officer can instruct the collaborative AI system to stop generating the recreation, such as through an input like a stop button. The collaborative AI system can then automatically generate a police report based on the interaction.

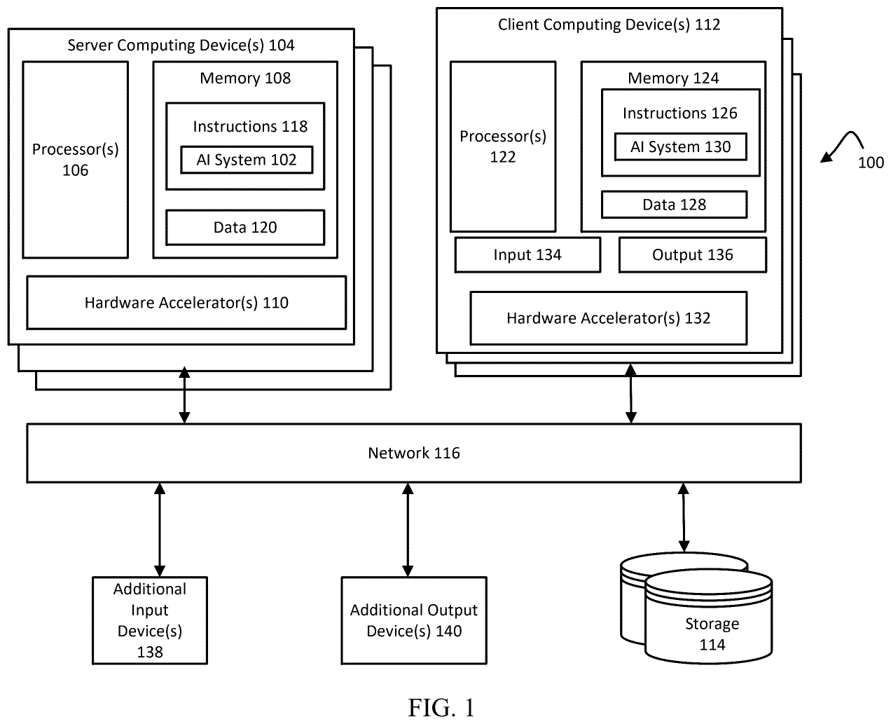

FIG. 1 depicts a block diagram of an example environment 100 for implementing a collaborative AI system 102. The collaborative AI system 102 can be implemented on one or more server computing devices 104 having one or more processors 106, memory 108, and/or hardware accelerators 110 in one or more locations. The server computing devices 104 can be communicatively coupled to one or more client computing devices 112 and/or one or more storage media 114 over a network 116.

The storage media 114 can be one or more databases, including a combination of volatile and non-volatile memory. The storage media 114 can be at the same or different physical locations than the server and client computing devices 104, 112. For example, the storage devices 114 can include any type of transitory or non-transitory computer readable medium capable of storing information, such as a hard-drive, solid state drive, tape drive, optical storage, memory card, ROM, RAM, DVD, CD-ROM, write-capable, and read-only memories.

The server and client computing devices 104, 112 can be capable of direct and indirect communication over the network 116. For example, using a network socket, the client computing devices 112 can connect to a service of the server computing devices 104 through an Internet protocol. The server and client computing devices 104, 112 can set up listening sockets that may accept an initiating connection for sending and receiving information. The network 116 can include various configurations and protocols including the Internet, World Wide Web, intranets, virtual private networks, wide area networks, local networks, and/or private networks using communication protocols. The network 116 can support a variety of short- and long-range connections. The short- and long-range connections may be made over different bandwidths, such as 2.402 GHz to 2.480 GHz, commonly associated with the Bluetooth® standard, 2.4 GHz and 5 GHz, commonly associated with the Wi-Fi® communication protocol; or with a variety of communication standards, such as the LTE® standard for wireless broadband communication. The network 116, in addition, or alternatively, can also support wired connections between the server and client computing devices 104, 112, including over various types of Ethernet connection. In some instances, protocols may include messaging platforms, such as neural automatic transport systems (NATs) and/or message queuing telemetry transport (MQTT).

Although a single server computing device 104 and client computing device 112 are depicted in FIG. 1, the environment 100 can include a variety of different configurations and quantities of computing devices, including paradigms for sequential or parallel processing or a distributed network of multiple devices.

The server computing device 104 can include one or more processors 106, memory 108, and/or hardware accelerators 110. The memory 108 can store information accessible by the processors 106 and/or accelerators 110, including instructions 118 that can be executed by the processors 106 and/or accelerators 110. The memory 108 can also include data 120 that can be retrieved, manipulated, or stored by the processors 106 and/or accelerators 110. The memory 108 can be a type of transitory or non-transitory computer readable medium capable of storing information accessible by the processors 106 and/or accelerators 110, such as volatile and non-volatile memory. The processors 106 can include one or more central processing units (CPUs), graphic processing units (GPUs), field-programmable gate arrays (FPGAs), and/or application-specific integrated circuits (ASICs). The hardware accelerators 110 can include one or more GPUs, FPGAs, and/or ASICs for deploying one or more AI models.

The instructions 118 can include one or more instructions that, when executed by the processors 106 and/or accelerators 110, cause the one or more processors and/or accelerators 110 to perform actions defined by the instructions 118. The instructions 118 can be stored in object code format for direct processing by the processors 106 and/or accelerators 110, or in other formats including interpretable scripts or collections of independent source code modules that are interpreted on demand or compiled in advance. The instructions 118 can include instructions for implementing the collaborative AI system 102 as described herein for generating a recreation of an interaction as the interaction is occurring and automatically drafting a police report based on the recreation. The collaborative AI system 102 can be executed using the processors 106 and/or accelerators 110, and/or using other processors and/or accelerators remotely located from the server computing device 104.

The data 120 can be retrieved, stored, or modified by the processors 106 and/or accelerators 110 in accordance with the instructions 118. The data 120 can be stored in computer registers, in a relational or non-relational database as a table having a plurality of different fields and records, or as JSON, YAML, proto, or XML documents. The data 120 can also be formatted in a computer-readable format such as, but not limited to, binary values, ASCII, or Unicode. Moreover, the data 120 can include information sufficient to identify relevant information, such as numbers, descriptive text, proprietary codes, pointers, references to data stored in other memories, including other network locations, or information that is used by a function to calculate relevant data.

The client computing device 112 can be configured similarly to the server computing device 104, with one or more processors 122, memory 124, instructions 126, and data 128. The client computing device 112 may also include the collaborative AI system 102 or, as depicted, another collaborative AI system 130. The client computing device 112 may further include one or more hardware accelerators 132 as well. The client computing device 112 can also include a user input 134 and a user output 136. The user input 134 can include any appropriate mechanism or technique for receiving input from a user, such as keyboard, mouse, mechanical actuators, soft actuators, touchscreens, microphones, and sensors. The client computing device 112 can be configured to display at least a portion of received data, such as data received from the server computing device 104, on a display implemented as part of the user output 136. The user output 136 can also be used for displaying an interface between the client computing device 112 and the server computing device 104. The user output 136 can alternatively or additionally include one or more speakers, transducers or other audio outputs, a haptic interface or other tactile feedback that provides non-visual and non-audible information to the user of the client computing device 112.

Although FIG. 1 illustrates the processors 106, 122, hardware accelerators 110, 132, and the memories 108, 124 as being respectively within the server and client computing devices 104, 112, components described herein can include multiple processors, accelerators, and memories that can operate in different physical locations and not within the same computing device. For example, some of the instructions 118, 126, and data 120, 128 can be stored on a removable SD card and others within a read-only computer chip. Some or all of the instructions and data can be stored in a location physically remote from, yet still accessible by, the processors 106, 122. Similarly, the processors 106, 122 can include a collection of processors that can perform concurrent and/or sequential operation. The server and client computing devices 104, 110 can each include one or more internal clocks providing timing information, which can be used for time measurement for operations and programs run by the server and client computing devices 104, 110.

The server computing device 104 can be configured to receive requests to process data from the client computing device 112. For example, the environment 100 can be part of a computing platform configured to provide a variety of services to users, through various user interfaces and/or application programming interfaces (APIs) exposing the platform services. The variety of services can include automatically generating a police report based on a recreation of an interaction. The client computing device 112 can transmit input data. The collaborative AI system 102 can receive the input data, and in response, generate output data including a recreation of an interaction between a police officer and an individual as the interaction is occurring.

The environment 100 can further include additional input devices 138 and additional output devices 140. The additional input devices 138 can include one or more sensors for providing input data to allow the AI system 102 to generate a recreation of the interaction. The sensors 138 can include temperature sensors, proximity sensors, accelerometers, infra-red-light sensors, smoke, gas or alcohol sensors, microphones, audio capture devices, video sensors, still image sensors, lidar sensors, thermal image sensors, and/or surveillance cameras, as examples. The additional input devices 138 can capture data during, before, and/or after a police officer is interacting with an individual for generation of the recreation of the interaction. The additional input devices 138 can be part of or separate from the input 134 described with respect to the client computing device 112.

The additional output devices 140 can output an automatically generated police report and/or the recreation of the interaction. The additional output devices 140 can include one or more monitors, smartphones, smartwatches, earbuds, headphones, tablets, personal computers, speakers, smart glasses, haptic devices, scent diffusers, as examples. The additional output devices 140 can output the automatically generated police report and/or the recreation any time after the interaction has occurred, even though the recreation is generated as the interaction is occurring. The additional output devices 140 can be part of or separate from the output 136 described with respect to the client computing device 112.

In operation, the collaborative AI system 102 may receive a request to generate a recreation of a police interaction. The request can be provided based on a police officer being dispatched to a scene by a dispatcher or the police officer turning on a computing device and/or sensor when arriving at the scene, as examples. Upon receiving the request, the collaborative AI system 102 can receive input data and process the input data using one or more AI models to generate a recreation of the police interaction as the interaction is occurring. The AI system 102 can further process the recreation using the one or more AI models to generate a police report of the interaction, generating as output data. The output data can be output to the client computing device 112, storage media 114, and/or the additional output devices.

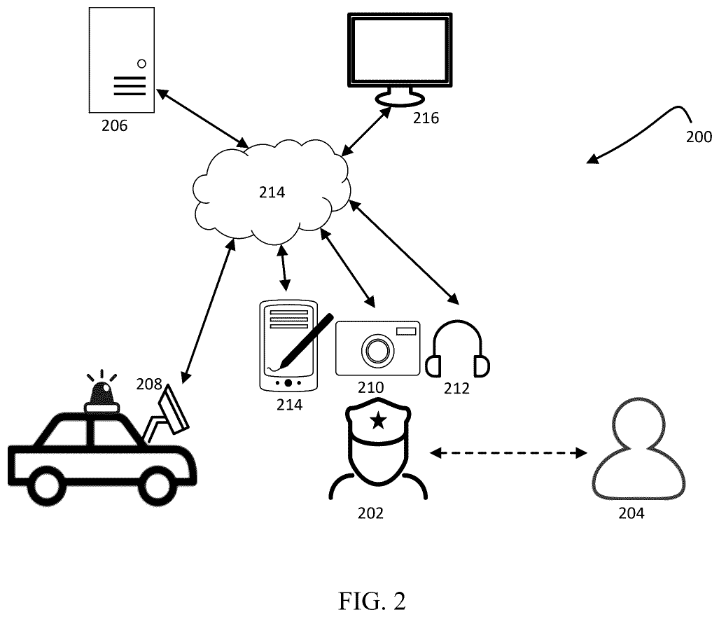

FIG. 2 depicts a diagram of an example use case scenario at a scene 200 where a police officer 202 interacts with an individual 204 and utilizes the collaborative AI system 206 to recreate the interaction in near real-time, e.g., as the interaction is occurring.

The interaction can be a traffic stop where a traffic violation was performed by the individual 204. The individual 204 here may also be referred to as a suspect. In this example, the police officer 202 pulls over the suspect 204. The police vehicle includes a dashboard camera 208. Further, the police officer 202 is wearing a camera 210, headset 212, and carrying a smartphone 214. The cameras 208, 210, headset 212, and smartphone 214 may correspond to input devices and/or client computing devices. While only a few input devices are depicted, there may be any number of input devices connected to any number of police officers and/or police vehicles. Further, while particular input devices are depicted, the police vehicle and/or police officer may input any type of input device, e.g., one or more different types of sensors.

The devices, e.g., the cameras 208, 210, headset 212, and smartphone 214, can collect input data associated with the interaction between the police officer 202 and the suspect 204, such as data corresponding to the scene 200 like imagery of objects in the vicinity of the vehicle as well as data related to the police officer 202 and suspect 204 like the conversation occurring between the police officer 202 and suspect 204. The input data can include data associated with images, video, audio, temperature, and/or scents associated with the interaction. The input data may further include behavioral information about the police officer 202 and/or suspect 204, such as demeanor and/or emotional characteristics, during the interaction.

The devices can send the input data captured during the police interaction to the collaborative AI system 206. In some instances, the devices can also send data captured before and/or after the interaction. The devices can communicate with the collaborative AI system 206 as well as with each other over a network 214. The collaborative AI system 206 can be configured to process the input data using one or more AI models to generate a recreation of the interaction between the police officer 202 and the suspect 204 as the interaction is occurring.

The collaborative AI system 206 can be implemented on one or more server computing devices, such as the server computing device 104 depicted in FIG. 1. The collaborative AI system 206 can generate a recreation of the interaction between the police officer 202 and the suspect 204 as the interaction is occurring based on the received input data from the devices. For example, the collaborative AI system 206 can receive a recording of a conversation between the police officer 202 and the suspect 204 through the headset 212 and/or smartphone 214 and use that recording to generate a transcript of the interaction as part of the recreation. As another example, the collaborative AI system 206 can receive image data from the dashboard camera 208 depicting a potential weapon on the suspect 204 and incorporate that the suspect 204 is potentially armed into the recreation. Any information received from the devices can be utilized as input data for recreating the interaction by the collaborative AI system 206. The collaborative AI system 206 can then use the recreation to generate a police report of the interaction.

The collaborative AI system 206 can output the police report and/or the generated recreation to a display 216. The display 216 can be separate from the police officer 202 as depicted in FIG. 2, such as at a dispatch in a police department. Alternatively, or additionally, the display 216 can be included as part of the police vehicle or smartphone 214 of the police officer 202.

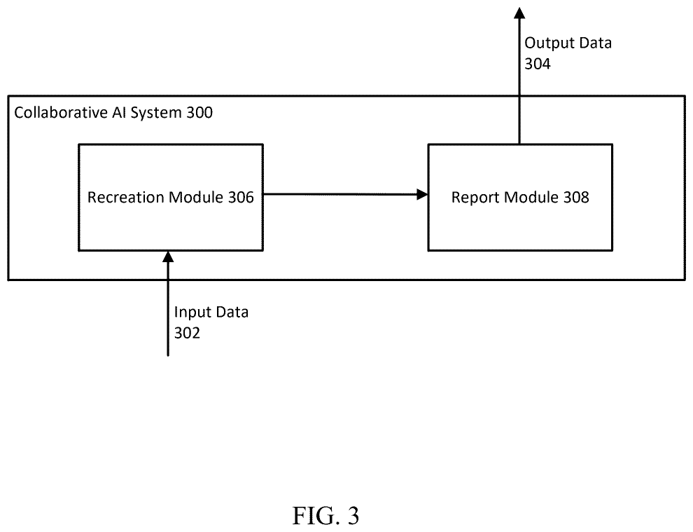

FIG. 3 depicts a block diagram of an example collaborative AI system 300 for automatically drafting police reports based on recreations of interactions generated as the interactions are occurring. The collaborative AI system 300 can be implemented across one or more computing devices in one or more locations, such as the collaborative AI system 102 as depicted in FIG. 1.

The collaborative AI system 300 can be configured to receive input data 302. For example, the collaborative AI system 300 can receive the input data 302 as part of a call to an application programming interface (API) exposing the collaborative AI system 300 to one or more computing devices over a network. As another example, the collaborative AI system 300 can receive the input data 302 from a storage medium, such as remote storage connected to the one or more computing devices over the network. As yet another example, the collaborative AI system 300 can receive the input data 302 from a user interface on a client computing device coupled to the collaborative AI system 300 over the network.

The input data 302 can correspond to real-time data streams captured from various sensors attached to the police officer, police vehicle, and/or surveillance systems in the vicinity of the interaction between the police officer and individual. The real-time data streams can include audio, video, image, and/or any other sensory data, such as voices and behaviors of the individual and/or police officer as well as potential weapons on or nearby the individual and/or smells associated with drugs of which the individual may be in possession. The input data 302 can further include historical data, such as prior police reports or data sent by a dispatcher about individuals relating to prior interactions with the individual. The input data 302 can also include metadata such as location data, time data, and/or sensor device data corresponding to where, when, and/or how the input data 302 was captured.

From the input data 302, the collaborative AI system 300 can be configured to output one or more results generated as output data 304, such as the police report and/or generated recreation. For example, the collaborative AI system 300 can be configured to provide the output data 304 as a set of computer-readable instructions, such as one or more computer programs. The computer programs can be written in any type of programming language, and according to any programming paradigm, e.g., declarative, procedural, assembly, object-oriented, data-oriented, functional, or imperative. The computer programs can be written to perform one or more different functions and to operate within a computing environment, e.g., on a physical device, virtual machine, or across multiple devices. The computer programs can also implement functionality described herein, for example, as performed by a system, engine, module, or model. As another example, the collaborative AI system 300 can be configured to forward the output data 304 to one or more other computing devices configured for translating the output data 304 into an executable program written in a computer programming language and optionally as part of a framework for automatically generating police reports. The collaborative AI system 300 can also be configured to send the output data 304 to a storage device for storage and later retrieval, such as a secure cloud storage platform. The collaborative AI system 300 can further be configured to send the output data 304 for display, such as on a display of a client device.

The collaborative AI system 300 can utilize the input data 302 and output data 304 to train and/or retrain one or more AI models configured to generate recreations of interactions as the interactions are occurring and then automatically generate police reports from the recreations. The AI models can be trained or retrained according to a variety of different learning techniques. Learning techniques for training the AI models can include supervised learning, unsupervised learning, semi-supervised learning techniques, parameter-efficient techniques, and/or reinforcement learning techniques. For example, input data and/or output data utilized as training data can include multiple training examples that can be received as input by the AI models. The training examples can be labeled with a desired output for the AI models when processing the labeled training examples. The label and the output can be evaluated through a loss function to determine an error, which can be back propagated through the AI models to update weights for the AI models. As another example, a supervised learning technique can be applied to calculate an error between outputs, with a ground-truth label of a training example processed by the AI models. Any of a variety of loss or error functions can be utilized, such as cross-entropy loss for classification tasks or mean square error for regression tasks. The gradient of the error with respect to the different weights of the AI models can be calculated, for example using backpropagation, and the weights for the AI models can be updated. The AI models can be trained until stopping criteria are met, such as a number of iterations for training, a maximum period of time, a convergence, or when a minimum accuracy threshold is met.

The one or more AI models can include machine learning models, statistical models, propensity scoring models, regression discontinuity models, classification models, potential outcomes models, quasiperiodic models, fractal models, and/or large language models or other large generative models, such as neural networks, convolutional neural networks, or deep neural networks, which can all be used in combination or in part for outputting police reports and generating recreations of interactions between police officers and individuals. The one or more AI models can include any machine learning model architecture, which may refer to characteristics defining the AI model, such as characteristics of layers for the model, how the layers process input, or how the layers interact with one another. The architecture of the machine learning model can also define the types of operations performed within each layer.

The collaborative AI system 300 can include a recreation module 306 and a report module 308. The recreation module 306 and report module 308 can be implemented as one or more computer programs and/or specially configured electronic circuitry.

The recreation module 306 can be configured to generate a recreation of an interaction between a police officer and an individual in near real time, e.g., as the interaction is occurring, based on the input data. The recreation module 306 can determine to initiate the generation of the recreation, such as from a request received by a dispatch or the police officer at the scene. The recreation module 306 can synchronize a plurality of input devices in the vicinity of the interaction between the police officer and the individual. The recreation module 306 can determine which input devices are within a threshold range of a primary device and synchronize the input devices within that threshold range. For example, the primary device can be a body camera worn by the police officer. The recreation module 306 can determine a dashboard camera on the police vehicle, a smartphone held by the police officer, and a plurality of surveillance cameras are within a threshold range of the body camera. The recreation module 306 can synchronize the input devices to be provided with consistent streams of input data over time for generating the recreation.

Based on the synchronized streams of input data, the recreation module 306 can generate the recreation of the interaction between the police officer and the individual as the interaction is occurring. The recreation module 306 can identify relevant information for preparing the report. For example, the recreation module 306 can utilize audio footage from one or more of the input devices to generate a transcript of any conversations between the police officer and individual. The recreation module 306 can further utilize audio footage to determine potential background noises relative to the police officer and individual, such as shots from a weapon or a victim screaming for help. As another example, the recreation module 306 can utilize video footage from different input devices, e.g., the body camera, dashboard camera, and/or surveillance cameras, to provide a depiction of the interaction from numerous angles for the recreation. As yet another example, the recreation module 306 can utilize the video footage and/or biological input data, e.g., blood pressure and/or heart rate, to determine the demeanor of the police officer and/or the individual. As yet another example, the recreation module 306 can utilize historical data like prior police reports, psychological reports, or identification information, e.g., driver's license number, officer badge numbers, vehicle license numbers, prior arrests, to identify the police officer and/or the individual in the recreation as well as potential behavioral characteristics of the police officer and/or the individual.

The recreation module 306 can utilize the various synchronized input devices to generate the recreation as the interaction is occurring. The recreation module 306 can determine the interaction is complete, either based on context of the interaction, e.g., the police officer is walking back to their police vehicle or states a phrase to the individual indicating the interaction is complete, such as “have a good night”, “drive slower next time”, or “call cleared”. The recreation module 306 can also be provided with a notification that the interaction is complete, such as from a dispatch, supervisor, or the police officer who took part in the interaction.

The report module 308 can be configured to generate a police report of the interaction based on generated recreation. The report module 308 can generate the police report immediately after the recreation module 306 determines the recreation is complete. The report module 308 can also generate the police report any time in the future by retrieving the recreation from storage. The report module 308 can parse the recreation to fill out particular sections of the police report. For example, the report module 308 can utilize the identified police officer and/or individual to fill out identification information about the police officer and/or individual. As another example, the report module 308 can utilize the transcript of the recreation to summarize conversations that took place between the police officer and the individual during the interaction. As yet another example, the report module 308 can utilize the recreation of the scene to provide details on how the police officer and/or the individual acted or moved around during the interaction and/or any other behavioral characteristics of the police officer and/or the individual. As yet another example, the report module 308 can utilize other aspects of the recreation, such as smells or sounds, to determine if the individual was potentially in possession of drugs or weapons. The report module 308 can provide a summary of the interaction based on the recreation. The report module 308 can output the police report, such as to the police officer or to a dispatch of the police department. The police officer or dispatch can verify the report and/or make any needed revisions. The verifications and/or revisions can further be utilized in training and/or retraining the AI models to improve accuracy in reporting drafting.

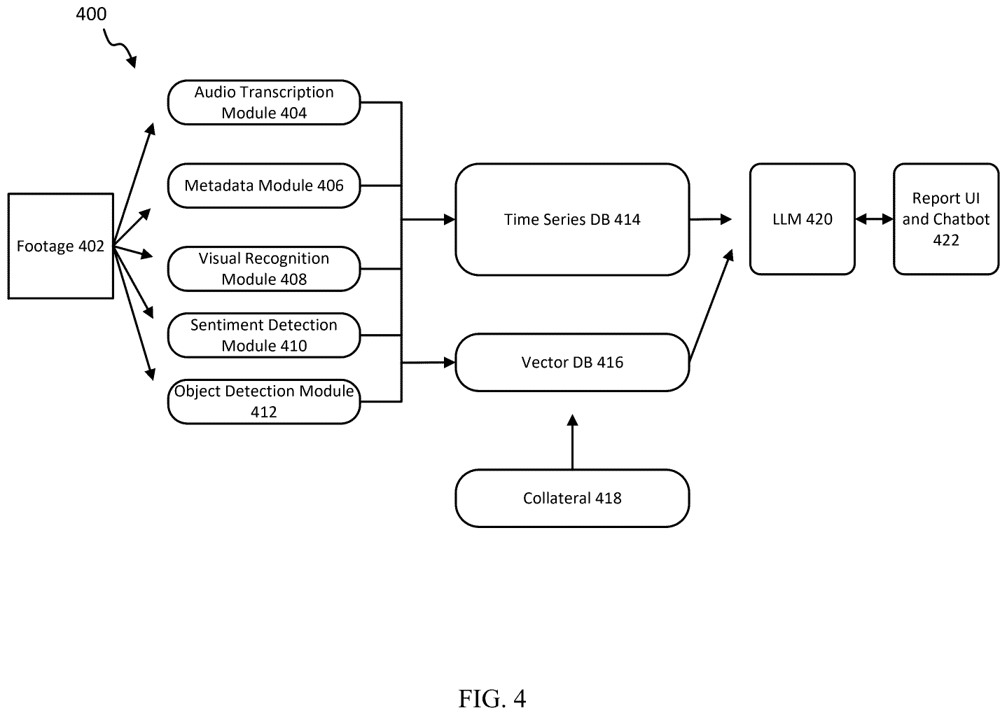

FIG. 4 depicts a block diagram of an example unbiased police reporting system 400. The unbiased police reporting system 400 can be implemented across one or more computing devices in one or more locations, such as the server computing device 104 as depicted in FIG. 1. The unbiased police reporting system 400 may receive the footage 402 from one or more sensors. The footage 402 may include video data, audio data, or image data captured using the one or more sensors. The one or more sensors may include temperature sensors, proximity sensors, accelerometers, infrared sensors, smoke, gas, or alcohol sensors, audio recorders, or video recorders. The one or more sensors can be attached to a police officer or police vehicle and may be continuously operable during an interaction between a police officer and an individual.

The unbiased police reporting system 400 may be implemented using a collaborative AI system 300 as depicted in FIG. 3. The unbiased police reporting system 400 can be configured to receive the footage 402 and process the received footage 402 using an audio transcription module 404, metadata module 406, visual recognition module 408, sentiment detection module 410, and object detection module 412. The audio transcription module 404, the metadata module 406, the visual recognition module 408, the sentiment detection module 410, and the object detection module 412 may be embedded in the recreation module 306 as depicted in FIG. 3.

The audio transcription module 404 may be configured to utilize audio data contained in the footage 402 to generate a transcript of the conversations between the police officer and any individuals. The audio transcription module 404 may be configured to process the received audio data using speaker diarisation techniques. The speaker diarisation techniques may refer to processes that partition audio streams into homogenous segments according to speaker identities. For example, when multiple police officers are interacting with multiple individuals, the audio transcription module 404 may discern respective voices to be associated with respective police officers or individuals, even when such multiple police officers and individuals are speaking at the same time. The audio transcription module 404 may independently and separately transcribe the speech of each police officer and individual. The audio transcription module 404 may analyze background noise and detect relevant sounds that need to be included in the report generated by the report module 308. For example, the audio transcription module 404 may be configured to detect various sounds such as gun sounds, car crash sounds, tire screech sounds, etc. and describe these sounds in an appropriate context.

The metadata module 406 can be configured to determine information about the environment in which the interaction of the police officer and the individual is taking place. For example, the metadata module 406 may be configured to retrieve information related to location, weather, traffic, and/or nearby businesses, such as from storage 114 as depicted in FIG. 1. The metadata module 406 may be configured to determine relevant information from the received information for generating the recreation via the recreation module 306 and include the relevant information in the report generated by the report module 308.

The visual recognition module 408 can be configured to select any visual data such as photographic and/or video data from the footage 402. The visual recognition module 408 can also be configured to identify respective persons depicted in the photographs or videos included in the footage 402. The visual recognition module 408 may be configured to identify demographic information related to the identified persons. For example, the visual recognition module 408 may be configured to identify the ethnicity, race, gender, addressee, and/or age of the identified persons. If the person was driving a vehicle, the visual recognition module 408 may also detect a license plate number and search the background information associated with the license plate number. If the identified person is a known person (e.g. celebrities, politicians, known criminals, fugitives, etc.), the visual recognition module 408 may be configured to search the background information of the known person and include the searched information in the report generated by the report module 308.

The sentiment detection module 410 can be configured to determine the sentiment and emotions of any identified persons based on the analysis of the facial expressions made by respective persons in the photographs or video data contained in the footage 402. For example, the sentiment detection module 410 can be configured to determine whether an individual being stopped by a police officer is expressing aggravated or annoyed feelings to the police officer. The report generated by the report module 308 can include the above sentiment or emotional information in the report to help explain particular behaviors or actions by any officers or individuals.

The object detection module 412 may be configured to detect one or more objects held by the individual or the police officer. For example, the object detection module 412 may recognize a gun or other type of weapon. The object detection module 412 may be configured to determine whether the individual holding a weapon is licensed to carry the weapon or the person is illegally carrying the weapon. In an example of a traffic stop, the object detection module 412 may be configured to determine whether the person was holding a cigarette, drug, cell phone, or any other electronic device or object that may distract the attention of the individual while driving a vehicle based on the video or photographs taken by the one or more sensors attached to the police car.

The recreation module 306 may store the information determined by the audio transcription module 404, the metadata module 406, the visual recognition module 408, the sentiment detection module 410, and the object detection module 412 in a time series database 414. The times series database may be equivalent to storage 114 as depicted in FIG. 1. The time series database 414 may store time-stamped or time series data. Time series data may refer to measurement data or event data that are monitored, tracked, and aggregated over a particular time period. The information determined by the audio transcription module 404, the metadata module 406, the visual recognition module 408, the sentiment detection module 410, and the object detection module may be time-stamped and stored as time series data in the time series database 414. For example, a critical portion of the dialogue between the police officer and the individual during a traffic stop may be time-stamped and stored with metadata indicating location information, the reason for the stop, and/or a type of traffic ticket issued by the police officer. The information stored in the time series database 414 may be transmitted to a generative model, such as a large language model (LLM) 420. LLM 420 can include artificial neural networks that can be trained to generate general-purpose language and perform natural language processing tasks. LLM 420 may be implemented using the AI system 102 as depicted in FIG. 1 and may include one or more AI models.

LLM 420 may also receive vector information from a vector database 416. The vector database 416 may store unstructured datasets with high dimensional vector embeddings, each dimension corresponding to a feature of the data. Each vector data may contain several dimensions ranging from small numbers of features to very large numbers of features up to a few thousand features. Each vector information may be depicted in a certain position in a vector space and each position may represent different characteristics, words, phrases, images, audio, and other type of data in the vector form.

The vector database 416 may also store a collateral 418. The collateral 418 may include any information that can add contextual and/or background information that may help broaden understanding of the recreation of the interaction between the police officer and the individual. Such information may include prior police reports, police documentation, individual documentation, relevant statutes like criminal codes, law enforcement reports comprising criminal records, psychological reports, mental facilities reports, correction facilities report, or previous dispatch data. The collateral 418 may also include a representative dataset that encompasses a broad range of perspectives on a societal issue while incorporating research studies and government reporting. The collateral 418 may be stored in the vector database 416 as a vector dataset. The vector information stored in the vector database 416 may be transmitted to LLM 420 and LLM 420 may generate a police report for display using a report UI and chatbot 422. LLM 420 and the report UI and chatbot 422 may be embedded in the report module as depicted in FIG. 3.

LLM 420 may receive time series data from the time series database 414 and vector data from vector database 416 to generate a written report based on the recreation of the interaction between the police officer and the individual when the reaction is occurring. LLM 420 may be configured to generate a template report with certain portions remaining blank such that the police officer may fill in the missing information. For example, the police officer may fill in one or more individuals' estimated height, weight, or colors of eyes and/or hair if the footage 402 captured by body cameras or surveillance cameras could not discern or provide such information to LLM 420.

LLM 420 can be configured to generate a report and display the report on a report user interface (UI). Report UI can be configured to be interactive such that a user may provide input such as notes or comments or fill in and/or correct any incorrect information contained in the report. LLM 420 can be trained to reduce or eliminate biases contained in the information received from both the time series database 414 and the vector database 416.

Bias-based profiling may lead to generations of a biased police report. Bias-based profiling may relate to the use of race, ethnicity, national origin, sex, economic status, age, disability, affiliation, or other perceived or actual characteristics of an individual as the basis for law enforcement action. Humans tend to be influenced by their biases, and it is difficult for human brains to process information without influence from these biases. On the other hand, LLM 420 can generate unbiased reports since the AI models embedded in LLM 420 are non-cognitive and have no preconceptions.

LLM 420 may be continuously and repeatedly audited by experts to ascertain that the outcome generated by LLM 420 is unbiased, not oversimplifying or stereotyping the police officer or the individual. The experts may include experts in various scientific fields such as psychologists, sociologists, historians, computer scientists, doctors, lawyers, scientists, etc. Auditing may include supervising the training of LLM 420 or providing feedback to LLM 420 based on the report generated by LLM 420. Such feedback may include information related to whether the report generated during training or inference was correct, partially correct, incorrect, etc. In this regard, the feedback received from the experts may be used as re-training data for LLM 420.

The computing devices of the collaborative AI system 300 may iterate the retraining process for LLM 420 until reaching an optimal stopping point. The optimal stopping point may be determined using objective representations, to maximize an expected level of unbiasedness and minimize an expected cost using objective representations and dynamic programming.

LLM 420 may also be trained with the outcome data of simulated training sessions configured to reduce potential bias in the generated report. Human experts may assist in determining whether the generated report is biased or unbiased relative to real-world observations. The human expert may provide feedback to LLM 420 and LLM 420 may update and refine LLM 420 to improve using the data captured during the interaction between the police officer and the individual in a real-world situation. This refined model can allow LLM 420 to improve, remaining accurate and unbiased in similar situations in the future. LLM 420 may be trained to ensure that the generated report contains objective information, not subjective information, and generate a report containing information suitable for the purposes of police reporting at scale.

Report UI and chatbot 422 may be configured to generate and display a draft report on the report UI or read out the draft report such that the police officer can listen to the reading of the report via additional output devices 140 (e.g. speaker) as depicted in FIG. 1. The police officer may directly speak to the report UI and chatbot 422 to provide feedback or provide any missing details. The police officer may speak to the report UI and chatbot 422 to orally approve the draft report. The police officer may also interact with the report UI and chatbot 422 by typing in the additional information. The police officer may approve and sign the draft report using a keyboard, mouse, or touch screen. In some embodiments, the report UI and chatbot 422 may recognize the police officer's particular motions, gestures, or facial expressions as approval of the generated report. The police officer may orally command the report UI and chatbot 422 to submit the approved report or enter a submission button using the keyboard, mouse, or touch screen. Any feedback provided by the police officer during the review and approval process may be stored, reviewed by human experts, and used to retrain LLM 420.

LLM 420 may also be fine-tuned to generate different types of reports. For example, LLM 420 may be trained to generate a variety of reports including accident reports, summaries of an incident, witness statements, victim impact statements, property damage reports, inter-jurisdictional reports, etc. using different formats or templates. LLM 420 may also be trained to generate different styles of reports based on different use case scenarios. LLM 420 may be trained to generate a specific style of summary reports of the recreation of the interaction between the police officer and the individual during a traffic stop. A different style of a report may be generated for the recreation of the interaction between the police officer and the individual during a criminal investigation. Another style of a report may be generated for dialogue between an individual and a dispatcher or call assistance over the phone. LLM 420 can also be trained to differentiate different types of police stops such as an ordinary traffic stop, and a Terry stop. Based on the different purposes of the police stops, LLM 420 may be trained to generate a pre-generated template according to each type of police stop. For example, LLM 420 may be trained to generate a template report containing particular sections tailored to detailed descriptions of suspicious objects or materials discovered in the individual's vehicle during the Terry stop. It is to be understood that LLM 420 may be trained to generate all other types of reports for any interactions between individuals and personnel from various departments, such as law enforcement departments and fire departments, hospitals, clinics, shelters, food kitchens, public transit, and/or departments of health, human services, social services, etc.

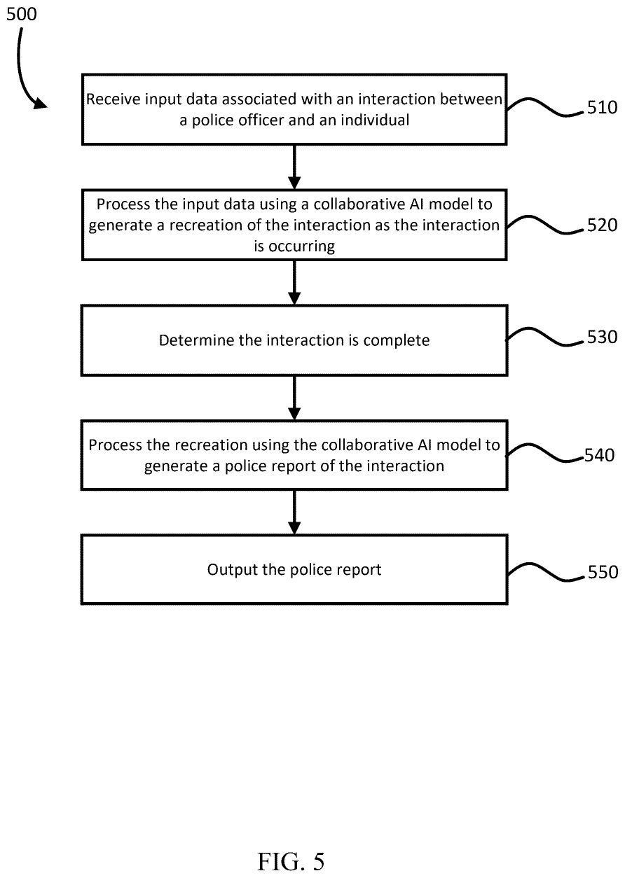

FIG. 5 depicts a flow diagram of an example process 500 for police reporting. The example process can be performed on a system of one or more processors in one or more locations, such as the collaborative AI system 300 as depicted in FIG. 3.

As shown in block 510, the collaborative AI system 300 receives input data associated with an interaction between an individual and a police officer. The input data can include video data, audio data, and/or image data captured using a plurality of sensors. The sensors can include temperature sensors, proximity sensors, accelerometers, infrared sensors, smoke, gas, and/or alcohol sensors, audio recorders, and/or video recorders. The sensors can be implemented in one or more input devices, such as smartphones, smart watches, surveillance cameras, body cameras, and/or dashboard cameras.

The collaborative AI system 300 can further receive historical data associated with the individual and the police officer. The historical data can include prior police reports, psychological reports, and/or identification information to identify the police officer and the individual. The historical data can further include social media posts, weather reports, or any other past information that is publicly available.

As shown in block 520, the collaborative AI system 300 processes the input data and/or the historical data using a collaborative AI model to generate a recreation of the interaction as the interaction is occurring. The collaborative AI system 300 can synchronize a plurality of sensors in the vicinity of the interaction to receive consistent streams of input data for generating the recreation in near real-time. For example, the collaborative AI system 300 can determine a plurality of sensors are within a threshold range of a primary sensor and synchronize streams of input data being provided from the plurality of sensors within that threshold range.

As shown in block 530, the collaborative AI system 300 determines the interaction is complete. The collaborative AI system 300 can utilize context to determine the interaction is complete or can receive a notification that the interaction is complete. For example, the collaborative AI system can determine the interaction is complete from actions of the police officer or phrases spoken by the police officer. As another example, the collaborative AI system can receive a notification from the police officer or a dispatch that the interaction is complete.

As shown in block 540, the collaborative AI system 300 processes the recreation using the collaborative AI model to generate a police report of the interaction. The collaborative AI system 300 can further process the historical data to generate the police report. The collaborative AI system 300 can parse the recreation to fill out various sections of the police report, such as identifying the police officer and the individual as well as summarizing the interaction that occurred.

As shown in block 550, the collaborative AI system 300 outputs the police report. The collaborative AI system 300 can store the police report in one or more storage devices and/or transmit the police report to a device associated with the police officer or a dispatch of a police department associated with the police officer. The device associated with the police officer or dispatch can be a laptop, smartphone, and/or smartwatch.

Aspects of this disclosure can be implemented in digital circuits, computer-readable storage media, as one or more computer programs, or a combination of one or more of the foregoing. The computer-readable storage media can be non-transitory, e.g., as one or more instructions executable by a cloud computing platform and stored on a tangible storage device.

The phrase “configured to” is used in different contexts related to computer systems, hardware, or part of a computer program. When a system is said to be configured to perform one or more operations, this means that the system has appropriate software, firmware, and/or hardware installed on the system that, when in operation, causes the system to perform the one or more operations. When some hardware is said to be configured to perform one or more operations, this means that the hardware includes one or more circuits that, when in operation, receive input and generate output according to the input and corresponding to the one or more operations. When a computer program is said to be configured to perform one or more operations, this means that the computer program includes one or more program instructions, that when executed by one or more computers, causes the one or more computers to perform the one or more operations.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method for police reporting comprising:
receiving, by one or more processors, input data associated with an interaction between at least one individual and a police officer;
processing, in real-time by the one or more processors, the input data using a collaborative artificial intelligence (AI) model to generate a recreation of the interaction as the interaction is occurring, wherein the collaborative AI model is trained to reduce a risk of biased police reporting in real time as the interaction is occurring based on one or more characteristics of the police officer;
determining, by the one or more processors, the interaction is complete;
processing, by the one or more processors, the recreation using the collaborative AI model to generate a police report of the interaction that is particular to the police officer and that reduces a risk of biased police reporting; and
outputting, by the one or more processors, the police report.

2. The method of claim 1, wherein the input data comprises at least one of video data, audio data, or image data captured using a plurality of sensors.

3. The method of claim 2, wherein the plurality of sensors comprises at least one of temperature sensors, proximity sensors, accelerometers, infrared sensors, smoke, gas, or alcohol sensors, audio recorders, or video recorders.

4. The method of claim 1, further comprising receiving, by the one or more processors, historical data associated with the at least one individual and the police officer.

5. The method of claim 4, further comprising processing the historical data using the collaborative AI model to generate the recreation of the interaction as the interaction is occurring.

6. The method of claim 4, wherein processing the recreation to generate the police report of the interaction is further based on the historical data.

7. The method of claim 4, wherein the historical data comprises at least one of prior police reports, psychological reports, or identification information.

8. The method of claim 1, wherein processing the input data using a collaborative artificial intelligence (AI) model to generate a recreation further comprises synchronizing a plurality of sensors to receive consistent streams of input data.

9. The method of claim 1, wherein outputting the police report further comprises storing the police report or transmitting the police report to a device associated with the police officer or a dispatch.

10. The method of claim 9, wherein the device associated with the police officer or dispatch comprises at least one of a laptop, smartphone, or smartwatch.

11. A system comprising:
one or more processors; and
one or more storage devices coupled to the one or more processors and storing instructions that, when executed by the one or more processors, cause the one or more processors to perform operations for police reporting, the operations comprising:
receiving input data associated with an interaction between at least one individual and a police officer;
processing, in real-time, the input data using a collaborative artificial intelligence (AI) model to generate a recreation of the interaction as the interaction is occurring, wherein the collaborative AI model is trained to reduce a risk of biased police reporting in real time as the interaction is occurring based on one or more characteristics of the police officer;
determining the interaction is complete;
processing the recreation using the collaborative AI model to generate a police report of the interaction that is particular to the police officer and that reduces a risk of biased police reporting; and
outputting the police report.

12. The system of claim 11, wherein the input data comprises at least one of video data, audio data, or image data captured using a plurality of sensors.

13. The system of claim 12, wherein the plurality of sensors comprises at least one of temperature sensors, proximity sensors, accelerometers, infrared sensors, smoke, gas, or alcohol sensors, audio recorders, or video recorders.

14. The system of claim 11, wherein the operations further comprise receiving historical data associated with the at least one individual and the police officer.

15. The system of claim 14, wherein the operations further comprise processing the historical data using the collaborative AI model to generate the recreation of the interaction as the interaction is occurring.

16. The system of claim 14, wherein processing the recreation to generate the police report of the interaction is further based on the historical data.

17. The system of claim 14, wherein the historical data comprises at least one of prior police reports, psychological reports, or identification information.

18. The system of claim 11, wherein processing the input data using a collaborative artificial intelligence (AI) model to generate a recreation further comprises synchronizing a plurality of sensors to receive consistent streams of input data.

19. The system of claim 11, wherein outputting the police report further comprises storing the police report or transmitting the police report to a device associated with the police officer or a dispatch.

20. A non-transitory computer readable medium for storing instructions that, when executed by one or more processors, cause the one or more processors to perform operations for police reporting, the operations comprising:
receiving input data associated with an interaction between at least one individual and a police officer;
processing, in real-time, the input data using a collaborative artificial intelligence (AI) model to generate a recreation of the interaction as the interaction is occurring, wherein the collaborative AI model is trained to reduce a risk of biased police reporting in real time as the interaction is occurring based on one or more characteristics of the police officer;
determining the interaction is complete;
processing the recreation using the collaborative AI model to generate a police report of the interaction that is particular to the police officer and that reduces a risk of biased police reporting; and
outputting the police report.
